(19) United States
(12) Patent Application Publication
(10) Pub. No.: US 2006/0195828 A1
(43) Pub. Date: Aug. 31, 2006

(54) Instruction generator, method for generating instructions and computer program product that executes an application for an instruction generator

(75) Inventors: Hiroaki Nishi, Yokohama-shi (JP); Nobu Matsumoto, Ebina-shi (JP); Yutaka Ota, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/362,125

(22) Filed: Feb. 27, 2006

(30) Foreign Application Priority Data
Feb. 28, 2005 (JP) 2005-055023

(51) Int. Cl. G06F 9/45

(52) U.S. Cl. 717/140

(57) ABSTRACT

An instruction generator comprising a storage device configured to store a machine instruction function incorporating both an operation definition defining a program description in a source program targeted for substitution to a SIMD instruction, and the SIMD instruction. A parallelism analyzer is configured to analyze the source program so as to detect operators applicable to parallel execution, and to generate parallelism information indicating the set of operators applicable to parallel execution. A SIMD instruction generator is configured to perform a matching determination between an instruction generating rule for the SIMD instruction and the parallelism information, and to read the machine instruction function out of the storage device in accordance with a result of the matching determination.

### CROSS REFERENCE TO RELATED APPLICATION AND INCORPORATION BY REFERENCE

This application is based upon and claims the benefit of priority from prior Japanese Patent Application P2005-055023 filed on Feb. 28, 2005; the entire contents of which are incorporated by reference herein.

### BACKGROUND OF THE INVENTION

1. Field of the Invention

The present invention relates to an instruction generator, a method for generating an instruction, and a computer program product for executing an application for the instruction generator, capable of generating a single instruction multiple data (SIMD) instruction.

2. Description of the Related Art

Same operations are often executed for a large amount of data in a multimedia application designed for image or audio processing. Accordingly, a processor embedding a multimedia extended instruction of a SIMD type for executing multiple operations with a single instruction is used for the purpose of improving the efficiency of the processing. To shorten a development period for a program and to enhance program portability, it is desirable to automatically generate a SIMD instruction from a source program described in a high-level language.

A multimedia extended instruction of a SIMD type may require special operation processes as shown in (1) to (5) below: (1) a special operator such as saturate calculation, an absolute value of a difference, and a high-order word of multiplication, and the like is involved; (2) different data sizes are mixed; (3) the same instruction can treat multiple sizes in a register-to-register transfer instruction (a MOV instruction), a logical operation, and the like as it is possible to interpret 64 bits operation as eight pieces of eight bits operations or four pieces of sixty bits operations; (4) input size may be different from output size; and (5) there is an instruction of changing some of operands.

A compiler for analyzing instructions in a C-language program applicable to parallel execution, and to generate SIMD instructions for executing addition-subtraction, multiplication-division, and other operations has been known as a SIMD instruction generating method for a SIMD arithmetic logic unit incorporated in a processor. There is also known a technique to allocate processing of a multiple for-loop script included in a C-language description to an N-way very long instruction word (VLIW) instruction, and thereby to allocate operations of respective nests to a processor array. A technique for producing a VLIW operator in consideration of sharing multiple instruction operation resources, has been reported.

However, there is no instruction generating method for generating an appropriate SIMD instruction when a SIMD arithmetic logic unit is embedded as a coprocessor independently of a processor core for the purpose of speeding up. Therefore, it has been expected to establish a method capable of generating an appropriate SIMD instruction for a SIMD coprocessor.

### SUMMARY OF THE INVENTION

An aspect of the present invention inheres in an instruction generator configured to generate an object code for a processor core and a single instruction multiple data (SIMD) coprocessor cooperating with the processor core, the instruction generator comprising, a storage device configured to store a machine instruction function incorporating both an operation definition defining a program description in a source program targeted for substitution to a SIMD instruction, and the SIMD instruction, a parallelism analyzer configured to analyze the source program so as to detect operators applicable to parallel execution, and to generate parallelism information indicating the set of operators applicable to parallel execution, a SIMD instruction generator configured to perform a matching determination between an instruction generating rule for the SIMD instruction and the parallelism information, and to read the machine instruction function out of the storage device in accordance with a result of the matching determination, and a SIMD compiler configured to generate the object code by substituting the program description coinciding with the operation definition in the source program, for the SIMD instruction, based on the machine instruction function.

Another aspect of the present invention inheres in a method for generating an instruction configured to generate an object code for a processor core and a SIMD coprocessor cooperating with the processor core, the method comprising, analyzing a source program so as to detect operators applicable to parallel execution, generating parallelism information indicating the set of operators applicable to the parallel execution, performing a matching determination between an instruction generating rule for a SIMD instruction and the parallelism information, acquiring a machine instruction function incorporating both an operation definition defining a program description in a source program targeted for substitution to the SIMD instruction, and the SIMD instruction, in accordance with a result of the matching determination, and generating the object code by substituting the program description coinciding with the operation definition in the source program, for the SIMD instruction, based on the machine instruction function.

Still another aspect of the present invention inheres in a computer program product for executing an application for an instruction generator configured to generate an object code for a processor core and a SIMD coprocessor cooperating with the processor core, the computer program product comprising, instructions configured to analyze a source program so as to detect operators applicable to parallel execution, instructions configured to generate parallelism information indicating the set of operators applicable to the parallel execution, instructions configured to perform a matching determination between an instruction generating rule for a SIMD instruction and the parallelism information, instructions configured to acquire a machine instruction function incorporating both an operation definition defining a program description in a source program targeted for substitution to the SIMD instruction, and the SIMD instruction, in accordance with a result of the matching determination, and instructions configured to generate the object code by substituting the program description coinciding with the operation definition in the source program, for the SIMD instruction, based on the machine instruction function.

### BRIEF DESCRIPTION OF THE DRAWINGS

FIG. 1 is a block diagram showing an instruction generator according to a first embodiment of the present invention.

FIG. 2 is a block diagram showing a processor targeted for generating an instruction by the instruction generator according to the first embodiment of the present invention.

FIG. 3 is a diagram showing a source program applied to the instruction generator according to the first embodiment of the present invention.

FIG. 4 is a diagram showing a program description after an expansion of a repetitive processing of the source program shown in FIG. 3.

FIG. 5 is a diagram showing a part of a directed acyclic graph (DAG) generated from the program description shown in FIG. 4.

FIG. 6 is a diagram showing an example of a part of a description of parallelism information according to the first embodiment of the present invention.

FIG. 7 is a diagram showing an example of a description of arithmetic logic unit area information according to the first embodiment of the present invention.

FIG. 8 is a diagram showing an example of a description in adding the arithmetic logic unit area information shown in FIG. 7 to the parallelism information shown in FIG. 6.

FIG. 9 is a diagram showing a set of instruction generating rule and a machine instruction function according to the first embodiment of the present invention.

FIG. 10 is a diagram showing a set of instruction generating rule and a machine instruction function according to the first embodiment of the present invention.

FIG. 11 is a block diagram showing an example of SIMD arithmetic logic units in a coprocessor targeted for generating an instruction by the instruction generator according to the first embodiment of the present invention.

FIG. 12 is a diagram showing an example of a description of arithmetic logic unit area information according to the first embodiment of the present invention.

FIG. 13 is a diagram showing an example of arithmetic logic unit area value macros generated by the determination module according to the first embodiment of the present invention.

FIG. 14 is a flow chart showing a method for generating an instruction according to the first embodiment of the present invention.

FIG. 15 is a flow chart showing a method for determining an instruction generating rule according to the first embodiment of the present invention.

FIG. 16 is a flow chart showing a method for generating an object code according to the first embodiment of the present invention.

FIG. 17 is a block diagram showing a parallelism analyzer according to a second embodiment of the present invention.

FIG. 18 is a flow chart showing a method for generating an instruction according to the second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

### First Embodiment

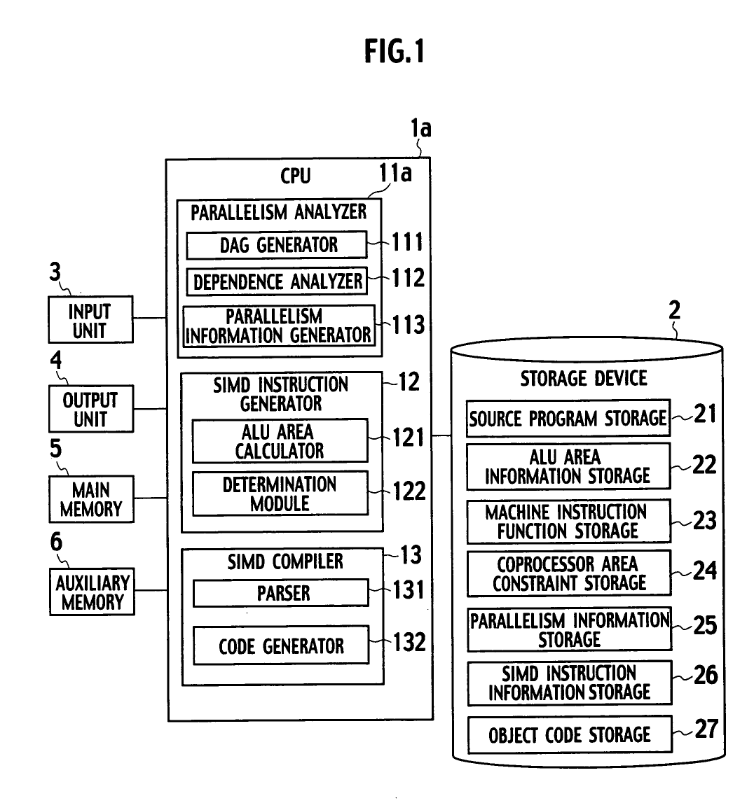

As shown in FIG. 1, an instruction generator according to a first embodiment of the present invention includes a central processing unit (CPU) 1a, a storage device 2, an input unit 3, an output unit 4, a main memory 5, and an auxiliary memory 6. The CPU 1a executes each function of a parallelism analyzer 11a, a single instruction multiple data (SIMD) instruction generator 12, and a SIMD compiler 13. The parallelism analyzer 11a acquires a source program from a storage device 2, then analyzes the source program to detect operators applicable to parallel execution, and generates parallelism information indicating a set of operators applicable to parallel execution and stores the parallelism information in the storage device 2. A computer program described by use of C-language can be utilized as the source program, for instance. The SIMD instruction generator 12 performs matching determination between an instruction generating rule applicable to a SIMD instruction to be executed by a SIMD coprocessor and the parallelism information. Then, in accordance with a result of the matching assessment, the SIMD instruction generator 12 reads a machine instruction function, which incorporates an operation definition defining a program description in the source program subject to be substituted for the SIMD instruction and the SIMD instruction, out of the storage device 2. Here, the “machine instruction function” refers to a description of the SIMD instruction as a function in a high-level language in order to designate the SIMD instruction unique to the coprocessor directly by use of the high-level language. The SIMD compiler 13 substitutes the program description in the source program coinciding with the operation definition for the SIMD instruction, based on the SIMD instruction incorporated in the machine instruction function, and generates an object code (machine language) including the SIMD instruction, thus storing the object code in the storage device 2.

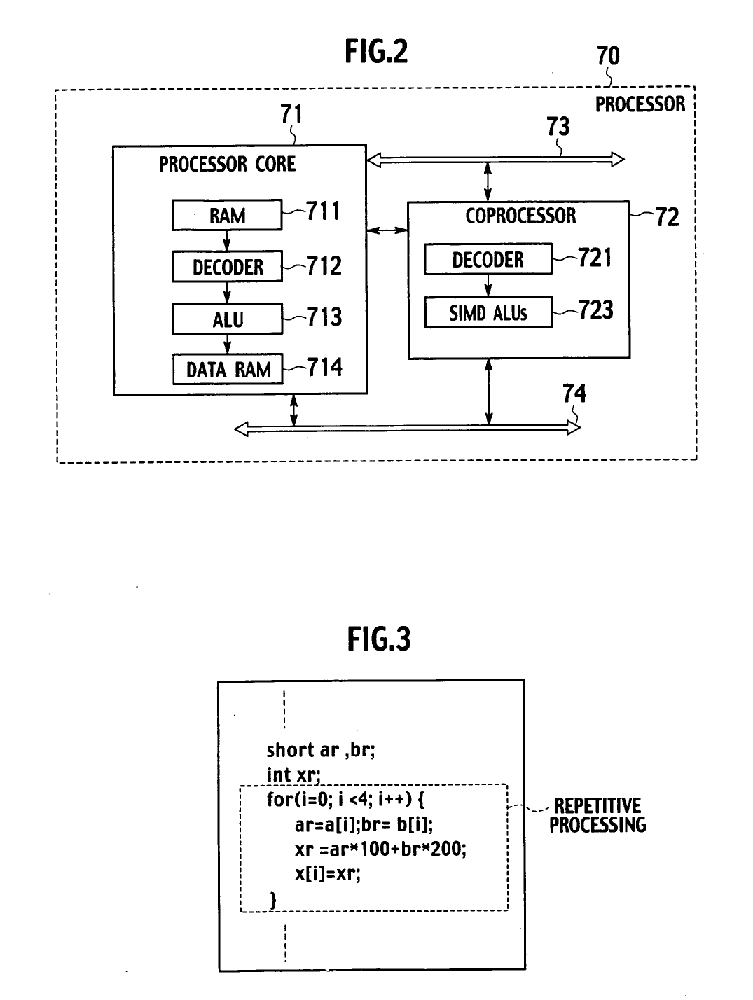

The instruction generating apparatus shown in FIG. 1 can generate a SIMD instruction to be executed by a SIMD coprocessor 72 operating in cooperation with a processor core 71, as shown in FIG. 2. In the example shown in FIG. 2, the SIMD instruction is stored in a random access memory (RAM) 711 of the processor core 71. The stored SIMD instruction is transferred to the coprocessor 72. The transferred SIMD instruction is decoded by the decoder 721. The decoded SIMD instruction is executed by the SIMD arithmetic logic unit 723.

The processor core 71 includes a decoder 712, arithmetic logic unit (ALU) 713, a data RAM 714, in addition to the RAM 711, for instance. A control bus 73 and data bus 74 connect between the processor core 71 and the coprocessor 72.

When the source program stored in the storage device 2 includes repetitive processing as shown in FIG. 3, processing time for the repetitive processing often dissatisfies specifications (required performances) only with the processor core 71 shown in FIG. 2. Accordingly, a processing speed of the entire processor 70 is improved by causing the coprocessor 72 to execute operations applicable to parallel execution in the repetitive processing.

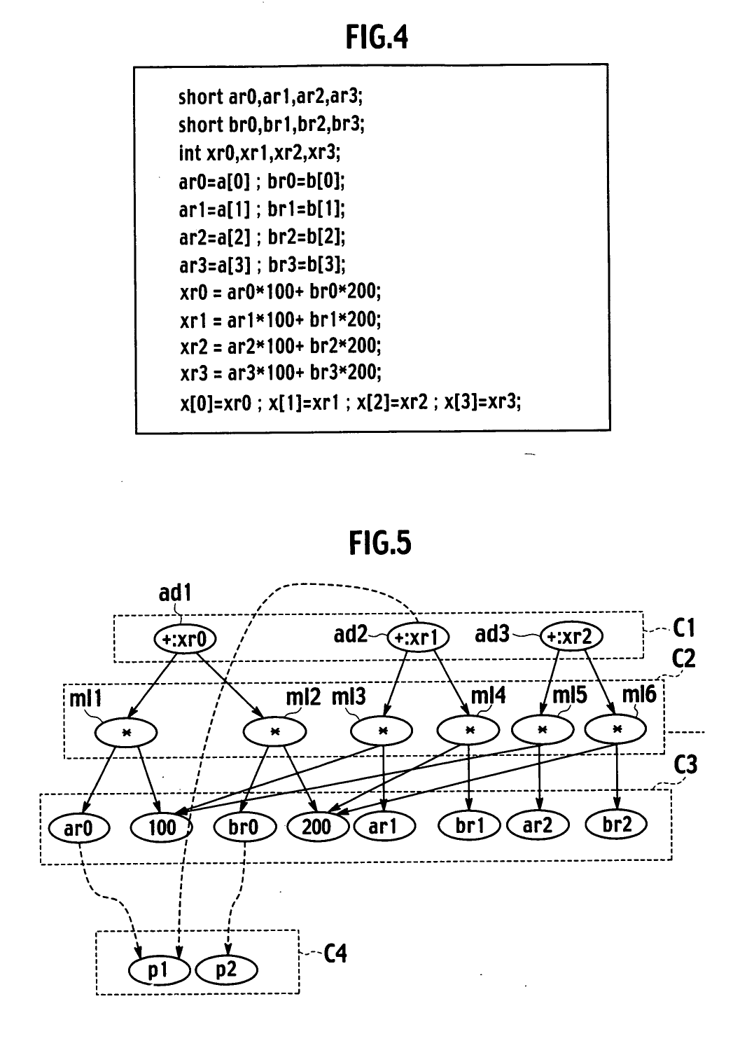

Furthermore, the parallelism analyzer 11a shown in FIG. 1 includes a directed acyclic graph (DAG) generator 111, a dependence analyzer 112, and a parallelism information generator 113. The DAG generator 111 performs a lexical analysis of the source program and then executes constant propagation, constant folding, dead code elimination, and the like to generate a DAG. In the example of the source program shown in FIG. 3, the repetitive processing of FIG. 3 is deployed by the DAG generator 111 as shown in FIG. 4. Part of the DAG generated from the program of FIG. 4 is shown in FIG. 5. It is to be noted, however, that only a part of the DAG is illustrated herein for the purpose of simplifying the explanation.

The dependence analyzer 112 traces the DAG and thereby checks data dependence of an operand on each operation on the DAG. In the DAG, an operator and a variable are expressed by nodes. A directed edge between the nodes indicates the operand (an input).

To be more precise, the dependence analyzer 112 checks whether an input of a certain operation is an output of an operation of a parallelism target. In addition, when the output of the operation is indicated by a pointer variable, the dependence analyzer 112 checks whether the variable is an input of the operation of the parallelism target. As a consequence, presence of dependence between the input and the output of the operation of the parallelism candidate is analyzed. Assuming that arbitrary two and more operations are selected and that there is dependence between operands of those operations, it is impossible to process those operations in parallel. Accordingly, a sequence of the operations is determined.

The dependence analyzer 112 starts the analysis from ancestral operation nodes (a node group C2 on the third tier from the bottom) of the DAG shown in FIG. 5. Operands (a node group C3 below the node group C2) of a multiplication (indicated with an asterisk *) ml1 are an operand ar0 (a short type) and a constant 100. Meanwhile, operands of a multiplication ml2 are an operand br0 (the short type) and a constant 200. As these constants are terminals, no tracing is carried out any further. From data types of the operands ar0 and br0, each of the multiplication ml1 and the multiplication ml2 can be regarded as a 16-bit signed multiplication (hereinafter expressed as “mul16s”).

The graph is traced further on the operands ar0 and br0. As indicated with dotted lines in FIG. 5, these operands reach terminal nodes p1 and p2 (different variables), respectively. Moreover, any of the terminal nodes p1 and p2 is not connected to output nodes (+:xr0) of the multiplication ml1 and of the multiplication ml2. Therefore, it is apparent that data dependence is not present between the operands of the multiplication ml1 and the multiplication ml2.

Next, data dependence between the multiplication ml1 and a multiplication ml3 is checked. Specifically, dependence between the operand ar0 and an operand ar1 is checked by tracing. The multiplication ml1 and the multiplication ml3 are applicable to parallelism if ancestral nodes of the operand ar0 and the operand ar1 are not respective parent nodes (+:xr1, +:xr0) of the multiplication ml3 and the multiplication ml1. However, the ancestral node p1 of the operand ar0 is connected to a child node +:xr1 in FIG. 5. Accordingly, data dependence is present between the multiplication ml1 and the multiplication ml3, and these multiplications are therefore not applicable to parallelism.

In this way, data dependence is checked similarly in terms of all pairs of multiplications including the pair of the multiplication ml1 and a multiplication ml4, the pair of the multiplication ml1 and a multiplication ml5, and so forth. When there is no data dependence between the operands of the multiplication ml1 and the multiplication ml5, these two multiplications are deemed applicable to parallelism. Moreover, the multiplication ml1 and the multiplication ml2 are applicable to parallelism as described previously. Therefore, the multiplication ml1, the multiplication ml2, and the multiplication ml5 are deemed applicable to parallelism.

After completing the data dependence analyses in terms of the multiplications, a parallelism analysis is performed on addition nodes (a node group C1) which are child nodes of the multiplications. Operands of an addition ad1 are the multiplication ml1 and the multiplication ml2 which are applicable to parallelism as described above. Accordingly, it is determined that the multiplication ml1, the multiplication ml2, and the addition ad1 are applicable to compound. Meanwhile, by use of a data type int of a variable xr0 which is a substitution target, this addition is regarded as a 32-bit signed addition (hereinafter expressed as “add32s”). Here, a result of addition is assigned to the variable of int. However, when the variable xr0 is expressed to be long, the addition is regarded as a 64-bit signed addition.

Thereafter, operands of the addition ad1 and an addition ad2 are traced. An output node of the addition ad2 is connected to the terminal node p1 of the addition ad1. Accordingly, it is determined that these two additions are inapplicable to parallelism. Then, operands are traced similarly on all additions to analyze data dependence between an output and an operand of a candidate operation for parallelism.

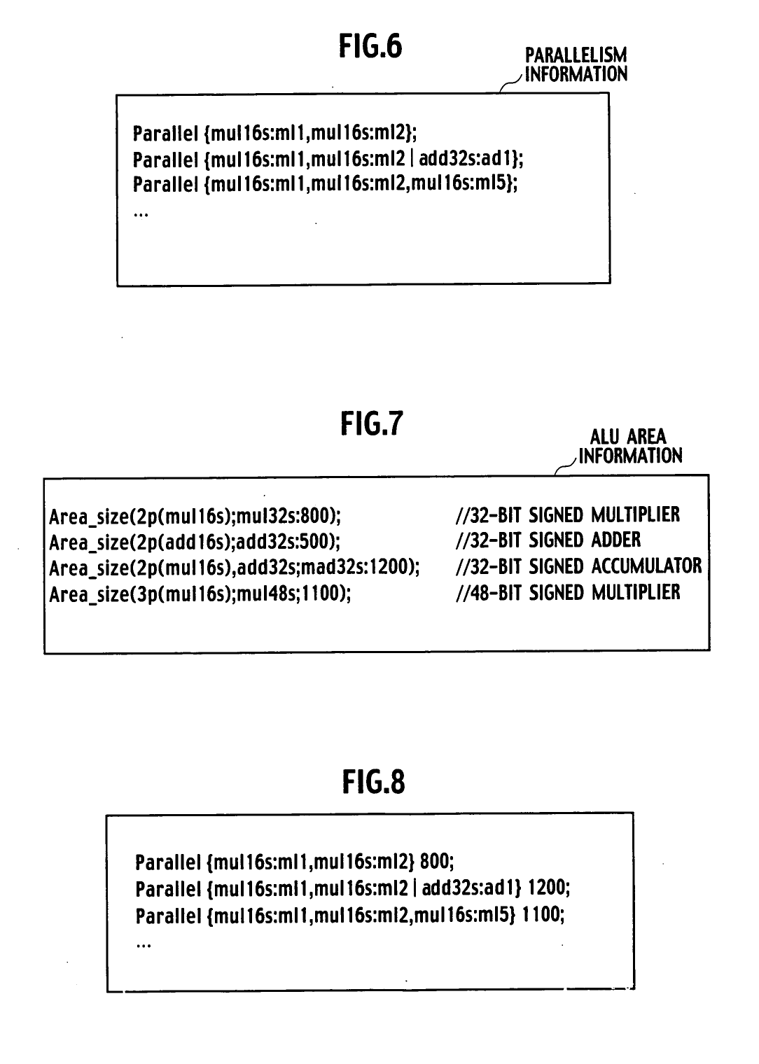

Further, the parallelism information generator 113 generates parallelism information as shown in FIG. 6 in accordance with results of analyses by the dependence analyzer 112. The parallelism information includes multiple parallel {an instruction type: ID list} descriptions. The instruction type is a name formed by connecting [an instruction name], [number of bits], and [sign presence]. A code “|” inside of { } in “parallel { }” means presence of an instruction applicable to composition. An instruction in front of the code “|” is referred to as a “former instruction” while an instruction behind the code “|” is referred to as a “latter instruction”. Although there is only one code “|” in this example, it is also possible to deal not only with two-stage instruction composition but also to multiple-stage instruction composition by use of multiple codes “|”.

In the example shown in FIG. 5, the multiplication ml1 and the multiplication ml2 are applicable to parallelism and are applicable to composition with the addition ad1 which is the child node. Moreover, the multiplication ml1, the multiplication ml2, and the multiplication ml5 are applicable to parallelism. Accordingly, the parallelism information is described as shown in the third line in FIG. 6. In FIG. 6, a code “mul” denotes a multiplication instruction and a code “add” denotes an addition instruction, respectively. Meanwhile, a numeral 16 denotes the number of bits and a code “s” denotes a signed operation instruction. An unsigned instruction does not include this code “s”.

The SIMD instruction generator 12 shown in FIG. 1 includes an arithmetic logic unit area calculator 121 and a determination module 122. The arithmetic logic unit area calculator 121 acquires a “parallel { }” list in the parallelism information and acquires a circuit area necessary for solely executing these instruction operations from arithmetic logic unit area information. The circuit area is composed of the number of gates corresponding to the respective operations, for example. The arithmetic logic unit area information is for instance described as a list as shown in FIG. 7. In FIG. 7, a code “2p” denotes two-way parallel, a code “;” denotes multiple operator candidates, “x, y” denotes an operator for executing a composite instruction from instructions x and y, and a numeral behind a code “:” denotes the number of gates.

For example, a size of a 32-bit signed multiplier for executing the 16-bit signed multiplication mul16s in two-way parallel is stored as 800 gates, a size of an adder for realizing the 32-bit signed addition add32s is stored as 500 gates, a size of a 32-bit signed multiplier-adder is stored as 1200 gates, and a size of a 48-bit signed multiplier is stored as 1100 gates.

Moreover, as shown in FIG. 8, the arithmetic logic unit area calculator 121 can extract the circuit scale of the operator from the arithmetic logic unit area information of FIG. 7, based on an instruction type of the parallelism information shown in FIG. 6. It is apparent that the operator for executing the operation mul16s included in the “parallel { }” description on the first line of the parallelism information in two-way parallel selects 2p (mul16s) and has the number of gates equal to 800 from the arithmetic logic unit area information. Similarly, the number of gates when the instruction included in “Parallel { }” is loaded on the operator, is acquired by additions, and appended.

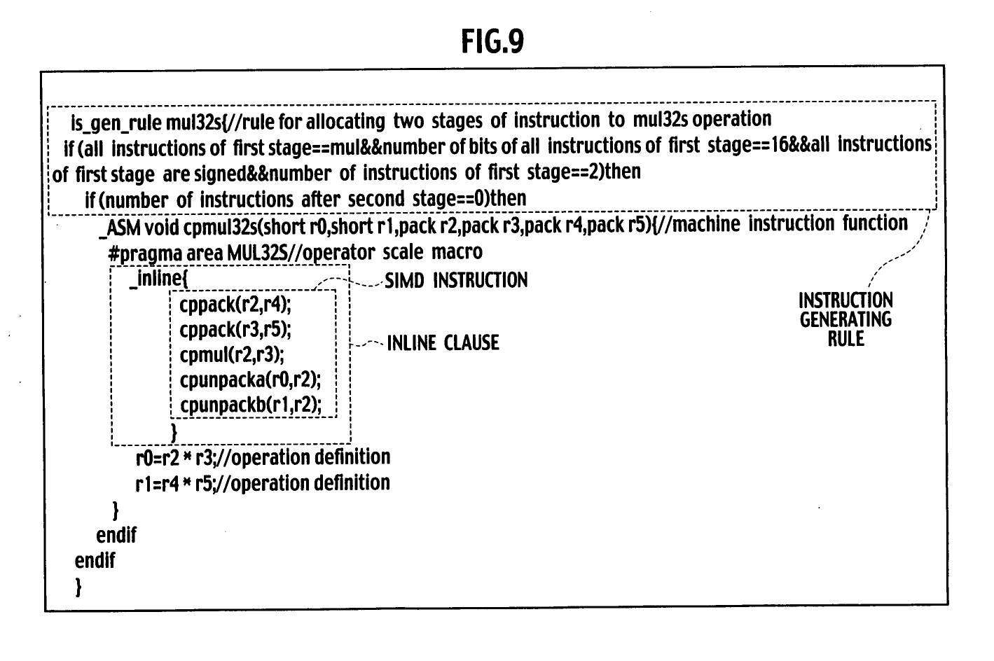

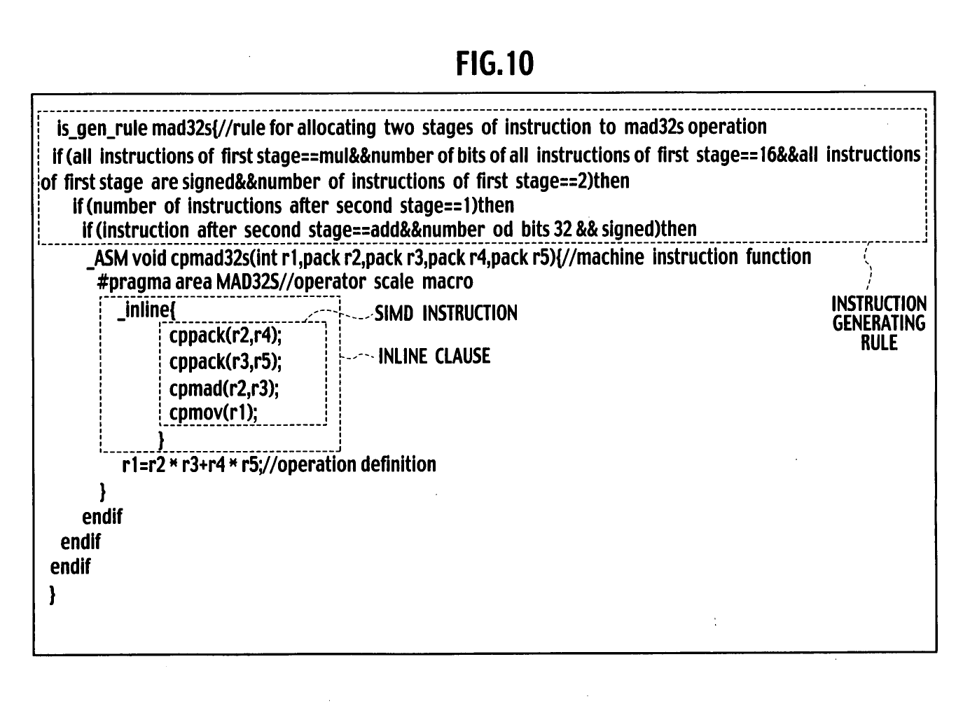

The determination module 122 generates the machine instruction function in terms of each “parallel { }” descriptions in the parallelism information, based on an instruction generating rule. As shown in FIG. 9 and FIG. 10, the instruction generating rule is described so that the machine instruction function corresponds to condition parameters of an instruction name, a bit width, a code, and the number of instructions. The instruction generating rule shown in FIG. 9 is a rule for allocating a two-way parallel multiplication instruction to mul32s operation (hereinafter referred to as “RULEmul32s”). Meanwhile, the instruction generating rule shown in FIG. 10 is a rule for allocating two stages of instructions to a mad32s composite operation (hereinafter referred to as “RULEmad32s”).

The RULEmad32s in FIG. 10 matches the “parallel { }” description on the second line in FIG. 8. Accordingly, a machine instruction function cpmad32 is selected. As a result, an arithmetic logic unit area macro is defined as “#define mad32s 1200”, for example. Meanwhile, the determination module 122 stores a group of definitions of the machine instruction functions corresponding to the instruction generating rule and the above-described definition of the arithmetic logic unit area macro in the storage device 2 collectively as SIMD instruction information when the instruction generating rule matches the parallelism information.

A parser 131 shown in FIG. 1 acquires the source program and the SIMD instruction information and converts the source program into a syntax tree. Then, the syntax tree is matched with a syntax tree for operation definitions of machine instruction functions in SIMD machine instruction functions.

A code generator 132 executes generation of SIMD instructions by substituting the source program for SIMD instructions within the range that satisfies a coprocessor area constraint, then convert into assembler descriptions. The syntax tree generated from the source program may include one or more syntax trees identical to the syntax tree generated from the operation definitions in the machine instruction functions. A SIMD instruction in an inline clause within the machine instruction function is allocated to each of the matched syntax trees of the source program. However, a hardware scale becomes too large if the SIMD arithmetic logic unit as well as input and output registers of the operator are prepared for each of the machine instruction functions. For this reason, one SIMD arithmetic logic unit is shared by the multiple SIMD operations.

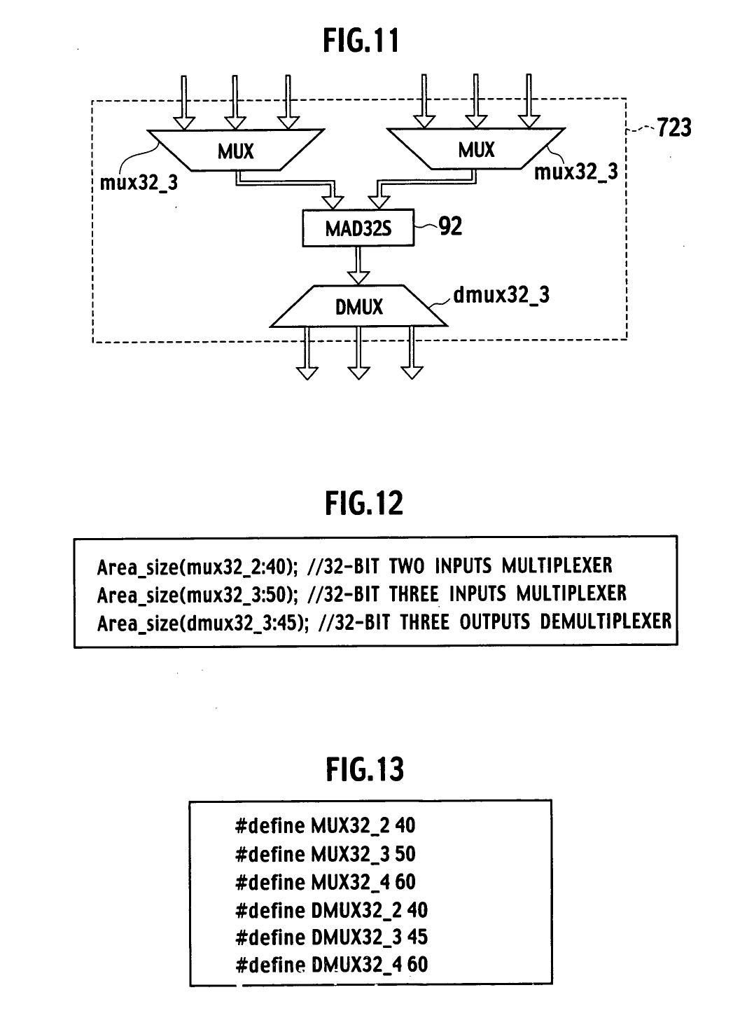

For example, when there are three machine instruction functions cmmad32, two multiplexers (MUX) 32_{—}3 for combining three 32-bit inputs into one input and one demultiplexer (DMUX) 32_{—}3 for splitting one 32-bit output into three 32-bit outputs are used for one mad32s operator 92 as shown in FIG. 11. The numbers of gates of the MUX_{—}32_{—}3 and the DMUX_{—}32_{—}3 are defined in the arithmetic logic unit area information as shown in FIG. 12. As a result, the numbers of gates of the MUX_{—}32_{—}3 and the DMUX_{—}32_{—}3 are defined together with the above-described arithmetic logic unit area macro. Information on the numbers of gates of the MUX_{—}32_{—}3 and the DMUX_{—}32_{—}3 is defined by the SIMD instruction generator 12 as shown in FIG. 13 as an arithmetic logic unit area macro definition of the machine instruction function.

Here, three or more machine instruction functions cpmad32s subject to be allocated are assumed to exist. Moreover, the SIMD arithmetic logic unit is assumed to be shared and the MUX and DMUX are assumed to be allocated. The code generator 132 of the SIMD compiler 13 acquires the above-described arithmetic logic unit area macro definition. When the coprocessor area constraint is set to 1350 gates, the code generator 132 allocates three machine instruction functions cpmad32. In this case, the total number of gates of the signed 32-bit multiplier-adder, the MUX_{—}32_{—}3, and the DMUX_{—}32_{—}3 is calculated as 1200+(50×2)+45=1345, which satisfies the restriction of 1350 gates. On the other hand, when there are three or more machine instruction functions cpmul32s and the coprocessor restriction is set to 1000 gates, the code generator 132 allocates three machine instruction functions cpmul32. The number of gates in this case is calculated as 800+(50×2)+45=945, which satisfies the coprocessor area constraint. The details about the code generator 132 will be described later.

The storage device 2 includes a source program storage 21, an arithmetic logic unit area information storage 22, a machine instruction storage 23, a coprocessor area constraint storage 24, a parallelism information storage 25, a SIMD instruction information storage 26, and an object code storage 27. The source program storage 21 previously stores the source program. The arithmetic logic unit area information storage 22 stores the arithmetic logic unit area information. The machine instruction storage 23 previously stores sets of the instruction generating rule and the machine instruction function. The coprocessor area constraint storage 24 previously stores the coprocessor area constraint. The parallelism information storage 25 stores the parallelism information generated by the parallelism information generator 113. The SIMD instruction information storage 26 the machine instruction function from the determination module 122. The object code storage 27 stores the object code including the SIMD instruction generated by the code generator 132.

The instruction generator shown in FIG. 1 includes a database controller and an input/output (I/O) controller (not illustrated). The database controller provides retrieval, reading, and writing to the storage device 2. The I/O controller receives data from the input unit 3, and transmits the data to the CPU la. The I/O controller is provided as an interface for connecting the input unit 3, the output unit 4, the auxiliary memory 6, a reader for a memory unit such as a compact disk-read only memory (CD-ROM), a magneto-optical (MO) disk or a flexible disk, or the like to CPU 1a. From the viewpoint of a data flow, the I/O controller is the interface for the input unit 3, the output unit 4, the auxiliary memory 6 or the reader for the external memory with the main memory 5. The I/O controller receives a data from the CPU 1a, and transmits the data to the output unit 4 or auxiliary memory 6 and the like.

A keyboard, a mouse or an authentication unit such as an optical character reader (OCR), a graphical input unit such as an image scanner, and/or a special input unit such as a voice recognition device can be used as the input unit 3 shown in FIG. 1. A display such as a liquid crystal display or a cathode-ray tube (CRT) display, a printer such as an ink-jet printer or a laser printer, and the like can be used as the output unit 4. The main memory 5 includes a read only memory (ROM) and a random access memory (RAM). The ROM serves as a program memory or the like which stores a program to be executed by the CPU 1a. The RAM temporarily stores the program for the CPU 1a and data which are used during execution of the program, and also serves as a temporary data memory to be used as a work area.

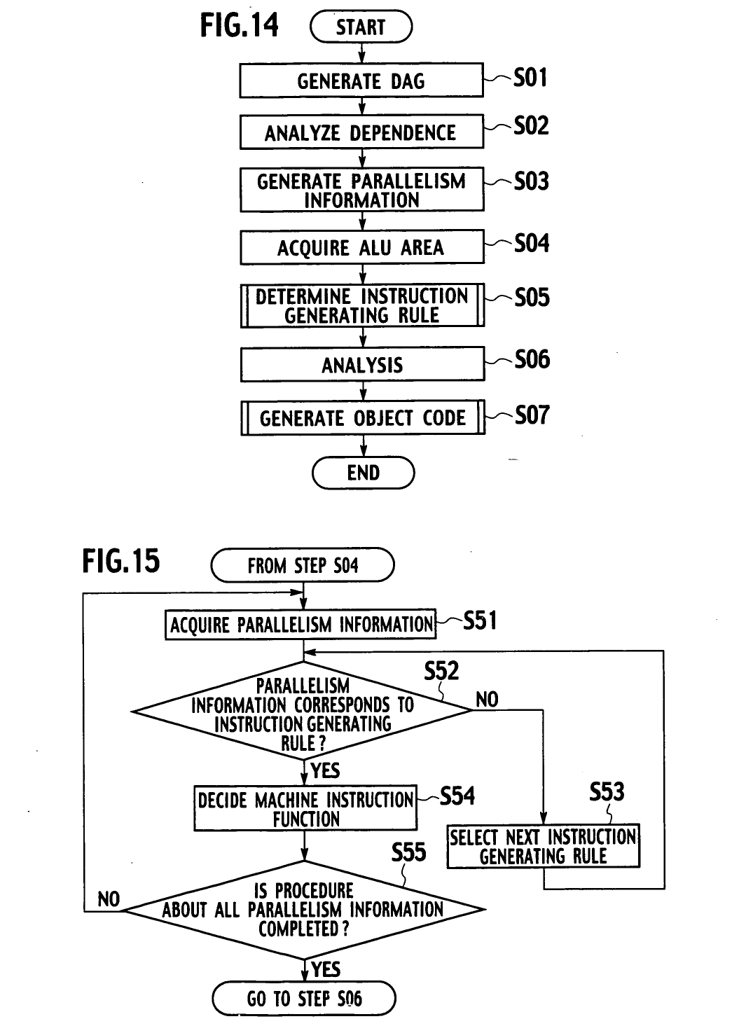

Next, the procedure of a method for generating an instruction according to the first embodiment of the present invention will be described by referring a flow chart shown in FIG. 14.

In step S01, the DAG generator 111 shown in FIG. 1 reads the source program out of the source program storage 21. The DAG generator 111 performs a lexical analysis of the source program and then executes constant propagation, constant folding, dead code elimination, and the like to generate the DAG.

In step S02, the dependence analyzer 112 analyzes data dependence of an operand on each operation on the DAG. That is, the dependence analyzer 112 checks whether an input of a certain operation is an output of an operation of a parallelism target.

In step S03, the parallelism information generator 113 generates the parallelism information for operators having no data dependence. The generated parallelism information is stored in the parallelism information storage 25.

In step S04, the arithmetic logic unit area calculator 121 calculates the entire arithmetic logic unit area by reading the circuit scale of the operators required for executing respective the parallelism information out of the arithmetic logic unit area information storage 22.

In step S05, the determination module 122 performs the matching determination between the instruction generating rule stored in the machine instruction function storage 23 and the parallelism information, and to read the machine instruction function out of the machine instruction function storage 23 in accordance with a result of the matching determination.

In step S06, the parser 131 acquires the source program from the source program storage 21, and executes a lexical analysis and a syntax analysis to the source program. As a result, the source program is converted into a syntax tree.

In step S07, the code generator 132 compares the syntax tree generated in step S06 with the operation definition of each machine instruction function. The code generator 132 replaces the syntax tree with the instruction sequence of the inline clause when the syntax tree and the operation definition correspond.

Next, the procedure of the instruction generating rule determination process shown in FIG. 14 will be described by referring a flow chart shown in FIG. 15.

In step S51, the determination module 122 reads the “parallel { }” description of the parallelism information out of the parallelism information storage 25.

In step S52, the determination module 122 determines the conformity between the instruction generating rule and the “parallel { }” description. The procedure goes to the step S54 when the instruction generating rule and the “parallel { }” description correspond. The procedure goes to the step S53, and the next instruction generating rule is selected when the instruction generating rule and the “parallel { }” description do not correspond.

In step S54, the determination module 122 selects a machine instruction function corresponding to the instruction generating rule, and adds an arithmetic logic unit area macro definition to the machine instruction function.

In step S55, the determination module 122 determines whether the matching determination about all “parallel { }” descriptions is completed. When it is determined that the matching determination about all “parallel { }” descriptions is not completed, the next “parallel { }” description is acquired in step S51.

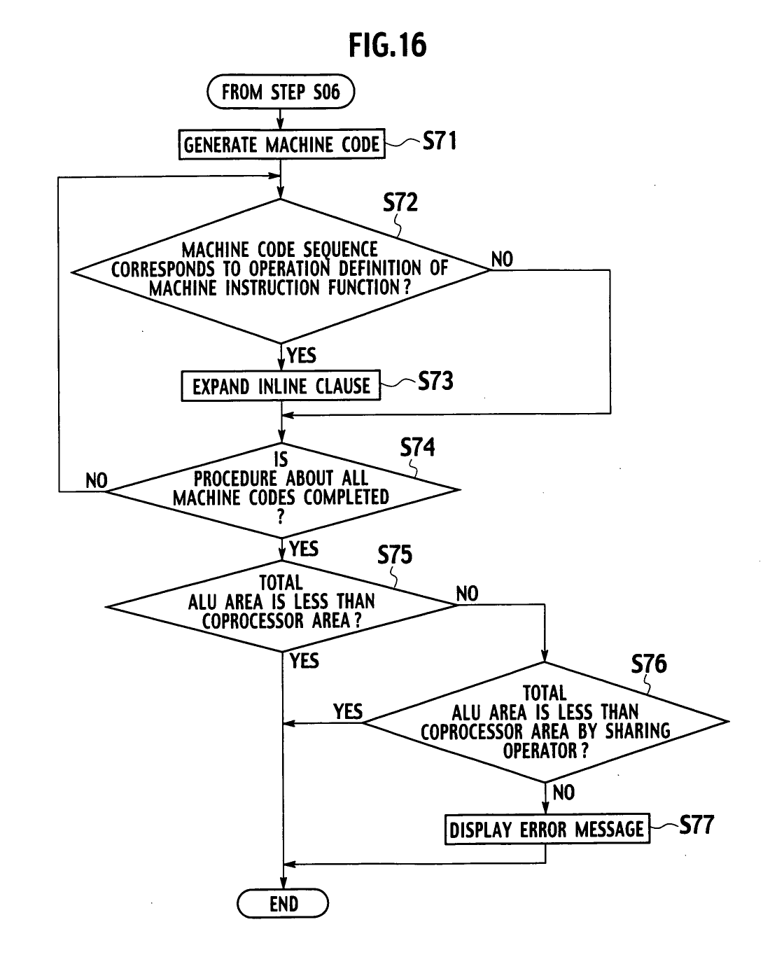

Next, the procedure of the object code generation process will be described by referring a flow chart shown in FIG. 16.

In step S71, the code generator 132 generates the object code from the syntax tree of the object code (machine code). The code generator 132 converts the operation definition in the machine instruction function stored in the SIMD instruction information storage 26 into the machine codes.

In step S72, the code generator 132 determines whether the machine codes sequence generated from the source program corresponds or resembles the converted operation definition. When it is determined that the machine codes sequence generated from the source program corresponds or resembles the converted operation definition, the procedure goes to step S73. When it is determined that the machine codes sequence generated from the source program does not correspond or resemble converted operation definition, the procedure goes to step S74.

In step S73, the code generator 132 replaces the machine codes sequence corresponding or similar to the converted operation definition with the SIMD instruction in the inline clause. The code generator 132 executes cumulative addition to the arithmetic logic unit area required for executing the replaced SIMD instruction, based on the arithmetic logic unit area macro definition.

In step S74, the code generator 132 determines whether the matching determination between the all machine codes generated from the source program and the converted operation definition is completed. When it is determined that the matching determination is completed, the procedure goes to step S75. When it is determined that the matching determination is not completed, the procedure returns to step S72.

In step S75, the code generator 132 determines whether a result of the cumulative addition is less than or equal to the coprocessor area constraint. When it is determined that the result of the cumulative addition is less than or equal to the coprocessor area constraint, the procedure is completed. When it is determined that the result of the cumulative addition is more than the coprocessor area constraint, the procedure goes to step S76.

In step S76, the code generator 132 determines whether an operator can execute a plurality of SIMD instructions. That is, the code generator 132 determines whether the coprocessor area constraint can be satisfied by sharing ALUs. When it is determined that coprocessor area constraint can be satisfied by sharing ALUs, the procedure is completed. When it is determined that coprocessor area constraint cannot be satisfied by sharing ALUs, the procedure goes to step S77. In step S77, an error message is informed to the user, and the procedure is completed.

As described above, according to the first embodiment, it is possible to provide the instruction generating apparatus and the instruction generating method capable of generating the appropriate SIMD instruction, for the SIMD coprocessor. Moreover, the determination module 122 is configured to acquire the machine instruction functions by using the name of the instruction applicable to parallelism, the number of bits of data to be processed by the instruction, and the information on presence of the code, as the parameters. In this way, the code generator 132 can generate the SIMD instruction, based on the acquired machine instruction function, so as to retain accuracy required for an operator of the coprocessor and so as to retain accuracy attributable to a restriction of description of a program language. Meanwhile, the code generator 132 for allocating the SIMD instruction can allocate the SIMD instruction in consideration of sharing of the SIMD arithmetic logic unit so as to satisfy the area constraint of the coprocessor.

### Second Embodiment

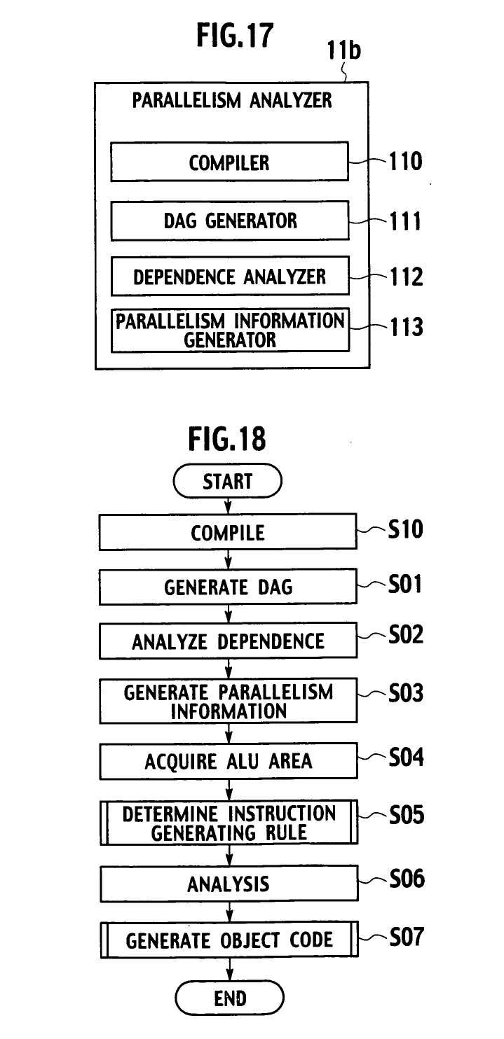

As shown in FIG. 17, an instruction generator according to a second embodiment of the present invention is different from FIG. 1 in that the parallelism analyzer 11b includes a compiler 110 configured to compile the source program into an assembly description. A conventional compiler for the processor core 71 shown in FIG. 2 can be utilized for the compiler 110. Other arrangements are similar to FIG. 1.

Next, the procedure of method for generating an instruction according to the second embodiment will be described with reference to a flow chart shown in FIG. 18. Repeated descriptions for the same processing according to the second embodiment which are the same as the first embodiment are omitted.

In step S10, the compiler 10 shown in FIG. 17 acquires the source program from the source program storage 21 shown in FIG. 1, and compiles the source program.

In step S01, the DAG generator 111 performs a lexical analysis of the assembly description and then executes constant propagation, constant folding, dead code elimination, and the like to generate the DAG.

As described above, according to the second embodiment, the DAG generator 111 can generate the DAG from the assembly description. Therefore, it becomes possible to deal with C++ language or FORTRAN language without limiting to the C language.

### Other Embodiments

Various modifications will become possible for those skilled in the art after receiving the teachings of the present disclosure without departing from the scope thereof.

For example, the instruction generator according to the first and second embodiments may acquire data, such as the source program, the arithmetic logic unit area information, the instruction generating rule, the machine instruction function, and the coprocessor area constraint, via a network. In this case, the instruction generator includes a communication controller configured to control a communication between the instruction generator and the network.

What is claimed is:

1. An instruction generator configured to generate an object code for a processor core and a single instruction multiple data (SIMD) coprocessor cooperating with the processor core, the instruction generator comprising:
a storage device configured to store a machine instruction function incorporating both an operation definition defining a program description in a source program targeted for substitution to a SIMD instruction, and the SIMD instruction;
a parallelism analyzer configured to analyze the source program so as to detect operators applicable to parallel execution, and to generate parallelism information indicating the set of operators applicable to parallel execution;
a SIMD instruction generator configured to perform a matching determination between an instruction generating rule for the SIMD instruction and the parallelism information, and to read the machine instruction function out of the storage device in accordance with a result of the matching determination; and
a SIMD compiler configured to generate the object code by substituting the program description coinciding with the operation definition in the source program, for the SIMD instruction, based on the machine instruction function.

2. The instruction generator of claim 1, wherein the machine instruction function is a description of the SIMD instruction as a function in a high-level language in order to designate the SIMD instruction unique to the coprocessor directly by use of the high-level language.

3. The instruction generator according to claim 1, wherein the parallelism analyzer detects operators applicable to the parallel execution by generating a directed acyclic graph from the source program.

4. The instruction generator of claim 3, wherein the parallelism analyzer comprises:
a directed acyclic graph generator configured to generate the directed acyclic graph;
a dependence analyzer configured to analyze a dependence between operands of operations on the directed acyclic graph by tracing the directed acyclic graph; and
a parallelism information generator configured to generate the parallelism information by determining that operations having no data dependence can execute in parallel.

5. The instruction generator of claim 4, wherein the directed acyclic graph generator deploys repetitive processing in the source program.

6. The instruction generator of claim 4, wherein the parallelism information includes an instruction type indicating an instruction name, number of bits, and sign presence.

7. The instruction generator of claim 1,
wherein the SIMD instruction generator acquires an arithmetic logic unit area of an operator for executing operator included in the parallelism information, and adds the arithmetic logic unit area to the machine instruction function, and
the SIMD compiler executes a cumulative addition of the arithmetic logic unit area in replacing a program description of the source program into the SIMD instruction, and determines whether a result of the cumulative addition is less than or equal to a hardware area constraint of the coprocessor.

8. The instruction generator of claim 7, wherein the SIMD instruction generator comprises:
an arithmetic logic unit area calculator configured to calculate the arithmetic logic unit area; and
a determination module configured to perform matching determination between the parallelism information and the instruction generating rule, and reads the machine instruction function out of the storage device in accordance with a result of the matching determination.

9. The instruction generator of claim 7, wherein the SIMD compiler comprises:
an analyzer configured to execute a lexical analysis and a syntax analysis to the source program, and converts the source program into a syntax tree; and
a code generator configured to generate the object code, to compare the syntax tree with the operation definition, and to replace the syntax tree with the SIMD instruction when the syntax tree and the operation definition correspond.

10. The instruction generator of claim 9, wherein the code generator determines whether hardware area constraint of the coprocessor can be satisfied by sharing an operator when it is determined that a result of the cumulative addition is more than the hardware area constraint of the coprocessor.

11. The instruction generator of claim 1, wherein the parallelism analyzer detects operators applicable to the parallel execution by generating a directed acyclic graph from a result of compilation of the source program.

12. The instruction generator of claim 11, wherein the parallelism analyzer comprises:
a directed acyclic graph generator configured to generate the directed acyclic graph;
a dependence analyzer configured to analyze a dependence between operands of operations on the directed acyclic graph by tracing the directed acyclic graph; and
a parallelism information generator configured to generate the parallelism information by determining that operations having no data dependence can execute in parallel.

13. The instruction generator of claim 11, wherein the parallelism information includes an instruction type indicating an instruction name, number of bits, and sign presence.

14. The instruction generator of claim 11,
wherein the SIMD instruction generator acquires an arithmetic logic unit area of an operator for executing operator included in the parallelism information, and adds the arithmetic logic unit area to the machine instruction function, and
the SIMD compiler executes a cumulative addition of the arithmetic logic unit area in replacing a program description of the source program into the SIMD instruction, and determines whether a result of the cumulative addition is less than or equal to a hardware area constraint of the coprocessor.

15. The instruction generator of claim 14, wherein the SIMD instruction generator comprises:
an arithmetic logic unit area calculator configured to calculate the arithmetic logic unit area ; and
a determination module configured to perform matching determination between the parallelism information and the instruction generating rule, and reads the machine instruction function out of the storage device in accordance with a result of the matching determination.

16. The instruction generator of claim 14, wherein the SIMD compiler comprises:
an analyzer configured to execute a lexical analysis and a syntax analysis to the source program, and converts the source program into a syntax tree; and
a code generator configured to generate the object code, to compare the syntax tree with the operation definition, and to replace the syntax tree with the SIMD instruction when the syntax tree and the operation definition correspond.

17. The instruction generator of claim 16, wherein the code generator determines whether hardware area constraint of the coprocessor can be satisfied by sharing arithmetic logic units when it is determined that a result of the cumulative addition is more than the hardware area constraint of the coprocessor.

18. A method for generating instructions generates an object code for a processor core and a SIMD coprocessor cooperating with the processor core, the method comprising:
analyzing a source program so as to detect operators applicable to parallel execution;
generating parallelism information indicating the set of operators applicable to the parallel execution;
performing a matching determination between an instruction generating rule for a SIMD instruction and the parallelism information;
acquiring a machine instruction function incorporating both an operation definition defining a program description in a source program targeted for substitution to the SIMD instruction, and the SIMD instruction, in accordance with a result of the matching determination; and
generating the object code by substituting the program description coinciding with the operation definition in the source program, for the SIMD instruction, based on the machine instruction function.

19. The method of claim 18, further comprising:
acquiring an arithmetic logic unit area of an operator for executing operator included in the parallelism information;
executing a cumulative addition of the arithmetic logic unit area in replacing a program description of the source program into the SIMD instruction; and
determining whether a result of the cumulative addition is less than or equal to a hardware area constraint of the coprocessor.

20. A computer program product that executes an application of an instruction generator configured to generate an object code for a processor core and a SIMD coprocessor cooperating with the processor core, the computer program product comprising:
instructions configured to analyze a source program so as to detect operators applicable to parallel execution;
instructions configured to generate parallelism information indicating the set of operators applicable to the parallel execution;
instructions configured to perform a matching determination between an instruction generating rule for a SIMD instruction and the parallelism information;
instructions configured to acquire a machine instruction function incorporating both an operation definition defining a program description in a source program targeted for substitution to the SIMD instruction, and the SIMD instruction, in accordance with a result of the matching determination; and
instructions configured to generate the object code by substituting the program description coinciding with the operation definition in the source program, for the SIMD instruction, based on the machine instruction function.
